(19) United States
(12) Patent Application Publication
(10) Pub. No.: US 2024/0166214 A1
(43) Pub. Date: May 23, 2024

(54) APPARATUS FOR PREDICTING A SPEED OF A VEHICLE AND A METHOD THEREOF

(71) Applicants: HYUNDAI MOTOR COMPANY, Seoul (KR); KIA CORPORATION, Seoul (KR)

(72) Inventors: Won Seok Jeon, Anyang-si (KR); Jung Hwan Bang, Seoul (KR); Hyung Seuk Ohn, Seoul (KR); Hee Yeon Nah, Seoul (KR); Ki Sang Kim, Seoul (KR); Byeong Wook Jeon, Seoul (KR); Dong Hoon Won, Suwon-si (KR); Dong Hoon Jeong, Seongnam-si (KR)

(73) Assignees: HYUNDAI MOTOR COMPANY, Seoul (KR); KIA CORPORATION, Seoul (KR)

(21) Appl. No.: 18/141,723

(22) Filed: May 1, 2023

(30) Foreign Application Priority Data
Nov. 18, 2022 (KR) 10-2022-0155704

(51) Int. Cl. B60W 40/105; G06N 3/0464; G06V 20/56

(52) U.S. Cl. CPC B60W 40/105; G06N 3/0464; G06V 20/588; B60W 2420/42; B60W 2554/80

(57) ABSTRACT

An apparatus and a method for predicting a speed of a vehicle. The apparatus includes storage that stores past driving information of the vehicle. The apparatus also includes a controller that extracts feature information about a current state of the vehicle from the past driving information of the vehicle. The controller also generates a query corresponding to each target time point based on the feature information. The controller also determines forward information corresponding to each target time point by using each query. The controller also predicts the speed of the vehicle at each target time point based on the query corresponding to each target time point and the forward information corresponding to each target time point.

### CROSS-REFERENCE TO RELATED APPLICATION

This application claims the benefit of and priority to Korean Patent Application No. 10-2022-0155704, filed in the Korean Intellectual Property Office on Nov. 18, 2022, the entire contents of which are incorporated herein by reference.

### TECHNICAL FIELD

The present disclosure relates to a technology for predicting a speed of a vehicle based on an artificial neural network model.

### BACKGROUND

In the field of artificial intelligence, an artificial neural network (ANN) is an algorithm that allows a machine to learn by simulating a human neural structure. Recently, ANNs have been applied to image recognition, speech recognition, natural language processing, and the like, and has shown excellent results. The artificial neural network includes an input layer that receives an input, a hidden layer that performs learning, and an output layer that returns a result of the operation. The artificial neural network including the plurality of hidden layers is called a deep neural network (DNN), which is also a type of artificial neural network.

The artificial neural network allows a computer to learn by itself based on data. When trying to solve a problem using the artificial neural network, a suitable artificial neural network model and data to be analyzed need to be prepared. The artificial neural network model to solve a problem is trained based on data. Before training the model, it is necessary to properly process the data first. This is because the input data and output data required by the artificial neural network model are standardized. Therefore, obtained raw data is typically processed to generate data suitable to be used as requested input data. The processed data are required to be divided into two types. In particular, the data should be divided into a training dataset and a validation dataset. The training dataset is used to train the model, and the validation dataset is used to verify the performance of the model.

There are various reasons for validating an artificial neural network model. An artificial neural network developer tunes the model by modifying the hyper parameters of a model based on the verification result of the model. In addition, the model verification is performed to select a suitable model from various models. The reason why the model verification is necessary is explained in more detail as follows.

The first reason is to predict accuracy. As a result, the purpose of artificial neural network is to achieve good performance on out-of-sample data not used for training. Therefore, after creating the model, it is essential to check how well the model will perform on out-of-sample data. However, because the model should not be verified using the training dataset, the accuracy of the model should be measured using the validation dataset separated from the training dataset.

The second reason is to increase the performance of the model by tuning the model. For example, it is possible to prevent overfitting. Overfitting means that the model is over-trained on the training dataset. For example, when the training accuracy is high but the validation accuracy is low, the occurrence of overfitting may be suspected. In addition, the occurrence of overfitting may be determined through training loss and validation loss. When overfitting occurs, it is necessary to prevent overfitting to increase the validation accuracy. It is possible to prevent overfitting by using a scheme such as regularization or dropout.

Meanwhile, in order to predict the speed of a vehicle at a target time point (e.g., 10 seconds later), a technique (e.g., an prediction technique based on a recurrent neural network (RNN)) for predicting the speed of a vehicle predicts the vehicle speed at the target time point (the time point to be predicted) in a scheme (serial scheme) of predicting the speed of the vehicle at a first time point (e.g., 1 second later), predicting a vehicle speed at a second time point based on the vehicle speed at the first time point, and predicting a vehicle speed at a third time point based on the vehicle speed at the second time point.

Because such a technique may not predict the speed of a vehicle at a target time point through a single operation and may only be predicted by performing several operations, it takes a long time to predict the vehicle speed at a target time point.

The matters described in this background section are intended to promote an understanding of the background of the disclosure and may include matters that are not already known to those of ordinary skill in the art.

### SUMMARY

The present disclosure has been made to solve the above-mentioned problems occurring in the art while advantages achieved by the prior art are maintained intact.

An aspect of the present disclosure provides an apparatus for predicting a speed of a vehicle and a method thereof capable of reducing the time required to predict the vehicle speed at each target time point. The apparatus and the vehicle may extract feature information about a current state of the vehicle from past driving information of the vehicle. The apparatus and the vehicle may also generate a query corresponding to each target time point based on the feature information. The apparatus and the vehicle may also determine forward information corresponding to each target time point by using each query. The apparatus and the vehicle may also predict the speed of the vehicle at each target time point based on the query corresponding to each target time point and the forward information corresponding to each target time point.

Another aspect of the present disclosure is to extract feature information about the current state of the vehicle from past driving information of the vehicle based on a first convolutional neural network (CNN).

Still another aspect of the present disclosure is to generate a query corresponding to each target time point by performing positional encoding on the feature information.

Still another aspect of the present disclosure is to generate the forward information corresponding to the distance to the vehicle based on positional encoding.

Still another aspect of the present disclosure is to determine an attention value for each forward information at each target time point based on an attention model (function) by using the forward information corresponding to each query and the distance from the vehicle.

Still another aspect of the present disclosure is to determine the forward information corresponding to each target time point from the degree of attention to each forward information at each target time point based on the second CNN.

Still another aspect of the present disclosure is to predict the amount of change in speed of the vehicle at each target time point based on the query corresponding to each target time point and the forward information corresponding to each target time point based on an inference layer.

Still another aspect of the present disclosure is to predict the speed of the vehicle at each target time based on the current speed of the vehicle and the amount of change in speed of the vehicle at each target time.

The technical problems to be solved by the present disclosure are not limited to the aforementioned problems. Any other technical problems not mentioned herein should be clearly understood from the following description by those having ordinary skill in the art to which the present disclosure pertains. Also, it should be easily understood that the objects and advantages of the present disclosure may be realized by the units and combinations thereof recited in the claims.

According to an aspect of the present disclosure, an apparatus for predicting a speed of a vehicle includes storage that stores past driving information of the vehicle. The apparatus also includes a controller that extracts feature information about a current state of the vehicle from the past driving information of the vehicle. The controller also generates a query corresponding to each target time point based on the feature information. The controller also determines forward information corresponding to each target time point by using each query. The controller also predicts the speed of the vehicle at each target time point based on the query corresponding to each target time point and the forward information corresponding to each target time point.

According to an embodiment, the controller may predict a speed change amount of the vehicle at each target time point based on the query corresponding to each target time point and the forward information corresponding to each target time point. The controller may also predict the speed of the vehicle at each target time point by adding the speed change amount of the vehicle at each target time point to a current speed of the vehicle.

According to an embodiment, the driving information may include at least one of a distance to a front vehicle, a relative speed with the front vehicle, a speed, a steering angle, an accelerator pedal sensor (APS) value, or a brake pedal sensor (BPS) value of the vehicle.

According to an embodiment, the forward information may include at least one of information about on a road on which the vehicle is traveling, traffic light information on the road, crosswalk information on the road, speed bump information on the road, and speed camera information on the road.

According to an embodiment, the controller may extract the feature information about the current state of the vehicle from the past driving information of the vehicle based on a first convolutional neural network (CNN).

According to an embodiment, the controller may generate the query corresponding to each target time point by performing positional encoding on the feature information about the current state of the vehicle.

According to an embodiment, the controller may obtain the forward information of the vehicle and perform positional encoding on the forward information of the vehicle to generate the forward information according to a distance to the vehicle.

According to an embodiment, the controller may input the forward information according to each query and the distance to the vehicle to an attention model. The controller may also determine an attention value for each forward information at each target time point based on the attention model.

According to an embodiment, the controller may determine the forward information corresponding to each target time point from the attention value for each forward information at each target time point based on a second convolutional neural network (CNN).

According to an embodiment, the controller may determine the forward information having greatest influence on the speed of the vehicle at each target time point as the forward information corresponding to each target time point.

According to another aspect of the present disclosure, a method of predicting a speed of a vehicle includes: extracting, by a controller, feature information about a current state of the vehicle from past driving information of the vehicle. The method also includes generating, by the controller, a query corresponding to each target time point based on the feature information. The method also includes determining, by the controller, forward information corresponding to each target time point by using each query. The method also includes predicting, by the controller, the speed of the vehicle at each target time point based on the query corresponding to each target time point and the forward information corresponding to each target time point.

According to an embodiment, the predicting of the speed of the vehicle may include predicting a speed change amount of the vehicle at each target time point based on the query corresponding to each target time point and the forward information corresponding to each target time point. The predicting of the speed of the vehicle may also include predicting the speed of the vehicle at each target time point by adding the speed change amount of the vehicle at each target time point to a current speed of the vehicle.

According to an embodiment, the extracting of the feature information may include extracting the feature information about the current state of the vehicle from the past driving information of the vehicle based on a first convolutional neural network (CNN).

According to an embodiment, the generating of the query may include generating the query corresponding to each target time point by performing positional encoding on the feature information about the current state of the vehicle.

According to an embodiment, the determining of the forward information may include obtaining the forward information of the vehicle. The determining of the forward information may also include performing positional encoding on the forward information of the vehicle to generate the forward information according to a distance to the vehicle. The determining of the forward information may also include inputting the forward information according to each query and the distance to the vehicle to an attention model. The determining of the forward information may also include determining an attention value for each forward information at each target time point based on the attention model. The determining of the forward information may also include determining the forward information corresponding to each target time point from the attention value for each forward information at each target time point based on a second convolutional neural network (CNN).

According to an embodiment, the determining of the forward information may include determining the forward information having greatest influence on the speed of the vehicle at each target time point as the forward information corresponding to each target time point.

### BRIEF DESCRIPTION OF THE DRAWINGS

The above and other objects, features, and advantages of the present disclosure should be more apparent from the following detailed description taken in conjunction with the accompanying drawings:

FIG. 1 is a diagram illustrating an apparatus for predicting a speed of a vehicle according to an embodiment of the present disclosure;

FIG. 2 is a diagram illustrating a result of predicting the speed of a vehicle by a controller provided in an apparatus for predicting a speed of a vehicle according to an embodiment of the present disclosure;

FIG. 3 is a block diagram illustrating a process of predicting a speed of a vehicle by a controller provided in an apparatus for predicting a speed of a vehicle according to an embodiment of the present disclosure;

FIG. 4 is a diagram illustrating a detailed process of predicting a speed of a vehicle by a controller provided in an apparatus for predicting a speed of a vehicle according to an embodiment of the present disclosure;

FIG. 5 is a view illustrating the performance of an apparatus for predicting a speed of a vehicle according to an embodiment of the present disclosure;

FIG. 6 is a graph illustrating the performance of an apparatus for predicting a vehicle speed according to an embodiment of the present disclosure;

FIG. 7 is a flowchart illustrating a method of predicting a speed of a vehicle according to an embodiment of the present disclosure; and

FIG. 8 is a block diagram illustrating a computing system for executing a method of predicting a speed of a vehicle according to an embodiment of the present disclosure.

### DETAILED DESCRIPTION

Hereinafter, some embodiments of the present disclosure are described in detail with reference to the drawings. In adding the reference numerals to the components of each drawing, it should be noted that the identical or equivalent component is designated by the identical numeral even when the components are displayed on other drawings. Further, in describing the embodiment of the present disclosure, a detailed description of the related known configuration or function has been omitted when it is determined that the related known configuration or function interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order, or sequence of the components. Unless otherwise defined, all terms including technical and scientific terms used herein have the same meaning as commonly understood by one of ordinary skill in the art to which this disclosure belongs. It should be further understood that terms, such as those defined in commonly used dictionaries, should be interpreted as having a meaning that is consistent with their meaning in the context of the relevant art and should not be interpreted in an idealized or overly formal sense unless expressly so defined herein. When a component, device, element, or the like of the present disclosure is described as having a purpose or performing an operation, function, or the like, the component, device, or element should be considered herein as being “configured to” meet that purpose or to perform that operation or function.

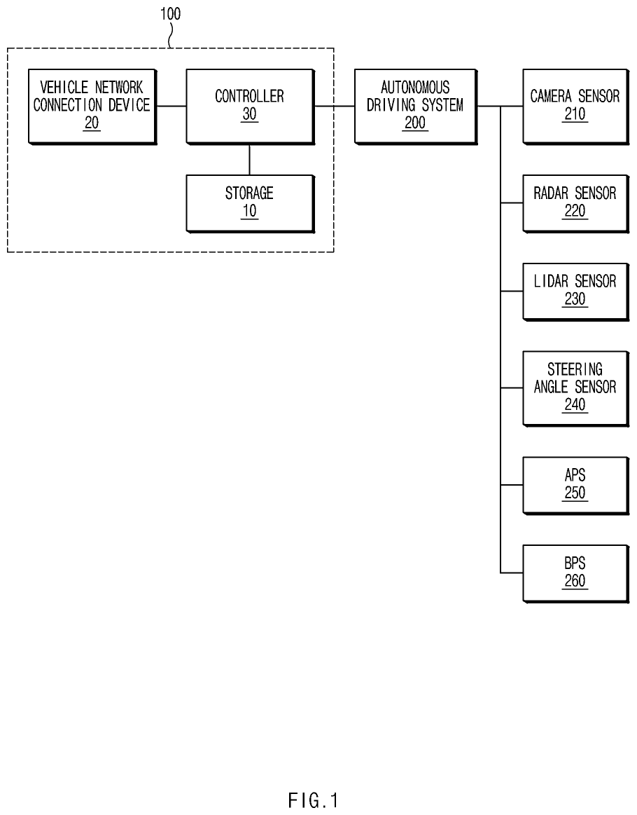

FIG. 1 is a diagram illustrating an apparatus for predicting a speed of a vehicle according to an embodiment of the present disclosure.

As shown in FIG. 1, an apparatus 100 for predicting a speed of a vehicle according to an embodiment of the present disclosure may include storage 10, a vehicle network connection device 20, and a controller 30. In this case, depending on a scheme of implementing an apparatus 100 for predicting the speed of a vehicle according to an embodiment of the present disclosure, components may be combined with each other to be implemented as one, or some components may be omitted.

Regarding each component, the storage 10 may store various logic, algorithms, and programs required in the following processes. The processes may include extracting feature information about a current state of the vehicle from past driving information of the vehicle. The processes may also include generating a query corresponding to each target time point based on the feature information. The processes may also include determining forward information corresponding to each target time point by using each query. The processes may also include predicting the speed of the vehicle at each target time point based on the query corresponding to each target time point and the forward information corresponding to each target time point. In this case, the forward information corresponding to each target time point means forward information having the greatest influence on the speed of the vehicle at each target time point.

The storage 10 may store a first convolutional neural network (CNN) used in a process of extracting feature information about a current state of a vehicle from past driving information of the vehicle.

The storage 10 may store positional encoding logic used in a process of generating a query corresponding to each target time point based on the feature information.

The storage 10 may store positional encoding logic used in a process of generating forward information corresponding to a distance to a vehicle.

The storage 10 may store an attention model (or function) used in a process of determining an attention value for each forward information at each target time point based on the forward information corresponding to each query and the distance to the vehicle. In this case, the attention model is a deep learning model learned to pay attention to different forward information at each target time point.

The storage 10 may store a second CNN used in a process of determining forward information corresponding to each target time point from the degree of attention of forward information at each target time point.

The storage 10 may store an inference layer used in a process of predicting a speed change amount of a vehicle at each target time point based on a query corresponding to each target time point and forward information corresponding to each target time point.

The storage 10 may include at least one type of a storage medium of memories of a flash memory type, a hard disk type, a micro type, a card type (e.g., a secure digital (SD) card or an extreme digital (XD) card), or the like. The storage 10 may also include at least one type of a random access memory (RAM), a static RAM, a read-only memory (ROM), a programmable ROM (PROM), an electrically erasable PROM (EEPROM), a magnetic memory (MRAM), a magnetic disk, an optical disk type memory, or the like.

The vehicle network connection device 20 may provide a connection interface with a vehicle network. The controller 30 may obtain, as driving information of a vehicle, a distance to a front vehicle, a relative speed with the front vehicle, a speed of a host vehicle, a steering angle, an accelerator pedal sensor (APS) value, a brake pedal sensor (BPS) value, and the like from the vehicle network. In this case, the vehicle network may include a controller area network (CAN), a CAN flexible data-rate (FD), a local interconnect network (LIN), FlexRay, media oriented systems transport (MOST), an Ethernet, and the like.

The controller 30 may perform overall control such that each component performs its function. The controller 30 may be implemented in the form of hardware or software or may be implemented in a combination of hardware and software. In an embodiment, the controller 30 may be implemented as a microprocessor but is not limited thereto.

Specifically, the controller 30 may perform various controls in the following processes. The processes may include extracting feature information about a current state of the vehicle from past driving information of the vehicle. The processes may also include generating a query corresponding to each target time point based on the feature information. The processes may also include determining forward information corresponding to each target time point by using each query. The processes may also include predicting the speed of the vehicle at each target time point based on the query corresponding to each target time point and the forward information corresponding to each target time point.

The controller 30 may extract feature information about the current state of the vehicle from past driving information of the vehicle based on a first convolutional neural network (CNN).

The controller 30 may generate a query corresponding to each target time point by performing positional encoding on the feature information.

The controller 30 may generate the forward information corresponding to the distance to the vehicle based on positional encoding. In this case, the controller 30 may obtain the forward information of the vehicle from an autonomous driving system 200. According to an embodiment of the present disclosure, the autonomous driving system 200 is described as an example, but any system may be used as long as the system can provide the forward information of the vehicle.

In this case, the autonomous driving system 200 may provide, as the forward information of a vehicle, information (type, curvature, slope, and the like) about a road on which the vehicle is traveling, traffic light information (lighting color) on the road, crosswalk information (separation distance from a host vehicle, location, and the like) on the road, speed bump information (separation distance from the host vehicle, location, and the like) on the road, speed camera information (separation distance from the host vehicle, location, and the like) on the road, and the like. The autonomous driving system 200 may include a camera sensor 210, a radio detection and ranging (RADAR) sensor 220, a light detection and ranging (LiDAR) sensor 230, a steering angle sensor 240, an APS 250, a BPS 260, and the like.

The camera sensor 210 may capture an image of the surroundings of the vehicle. Such a camera sensor may include a front camera that photographs a front image of the vehicle, a left side camera that photographs an image of the left side of the vehicle, a right side camera that photographs an image of the right side of the vehicle, and a rear camera that photographs a rear image of the vehicle.

The radar sensor 220 may include a first radar sensor located in front of the vehicle to measure the distance and relative speed with a front vehicle. The radar sensor 220 may also include a second radar sensor located in the left side of the vehicle to measure the distance and relative speed with a vehicle in the left side. The radar sensor 220 may also include a third radar sensor located on the right side of the vehicle to measure the distance and relative speed with a vehicle in the right side. The radar sensor 220 may also include a fourth radar sensor located at the rear of the vehicle to measure the distance and relative speed to a rear vehicle.

The lidar sensor 230, which is a module that generates a 3D image of objects around the vehicle, may track the speed of the vehicle as well as the driving path of the surrounding objects.

The steering angle sensor 240 may measure the steering angle of the vehicle.

The APS 250 is a sensor that measures the degree (hereinafter, referred to as an APS value) of depression of the accelerator pedal provided in the vehicle. When a driver does not operate the accelerator pedal (APS OFF), the APS value is 0%. When the driver depresses the accelerator pedal up to the maximum, the APS value is 100%.

The BPS 260 is a sensor that measures the degree (hereinafter, referred to as a BPS value) of depression of the brake pedal provided in the vehicle. When the driver does not operate the brake pedal (BPS OFF), the BPS value is 0%. When the driver depresses the brake pedal up to the maximum, the BPS value is 100%.

The controller 30 may determine an attention value for each forward information at each target time point based on an attention model (function) by using the forward information corresponding to each query and the distance from the vehicle.

The controller 30 may determine the forward information corresponding to each target time point from the degree of attention to each forward information at each target time point based on the second CNN. For example, the controller 30 may pay attention to traffic light information at the first target time point, pay attention to crosswalk information at the second target time point, and pay attention to a speed bump at the third target time point.

The controller 30 may predict the amount of change in speed of the vehicle at each target time point based on the query corresponding to each target time point and the forward information corresponding to each target time point based on an inference layer.

The controller 30 may predict the speed of the vehicle at each target time point based on the current speed of the vehicle and the amount of change in speed of the vehicle at each target time point.

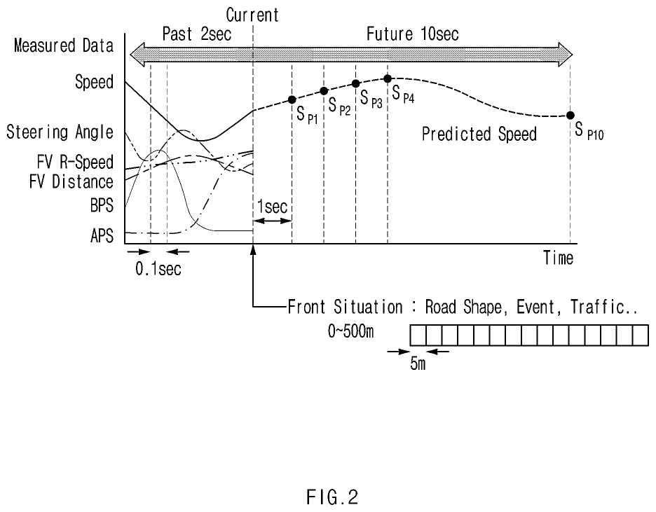

Hereinafter, the operation of the controller 30 is described in detail with reference to FIGS. 2, 3, and 4.

FIG. 2 is a diagram illustrating a result of predicting the speed of a vehicle by a controller provided in an apparatus for predicting a speed of a vehicle according to an embodiment of the present disclosure.

In FIG. 2, the horizontal axis represents time, and the vertical axis represents vehicle driving information. S_{P1}, which is a prediction result, represents the speed of the vehicle at 1 second after the start of prediction (current). S_{P2}, which is a prediction result, represents the speed of the vehicle at 2 seconds after the start of prediction (current). S_{P3}, which is a prediction result, represents the speed of the vehicle at 3 seconds after the start of prediction (current). S_{P4}, which is a prediction result represents the speed of the vehicle at 4 seconds after the start of prediction (current). S_{P10} is a prediction result and indicates the speed of the vehicle at 10 seconds after the start of prediction (current). In this case, the key point of the present disclosure is that it is not a scheme (serial scheme) of sequentially predicting the speed of the vehicle from 1 second to 10 seconds after the start of the prediction, but a scheme (parallel scheme) of predicting the speed of the vehicle from 1 second to 10 seconds after the start of the prediction in batches.

As shown in FIG. 2, the controller 30 may predict the speed of the vehicle for the next 10 seconds based on vehicle driving information for the past 2 seconds based on the time point (current) at which the prediction is started. In this case, the driving information of the vehicle includes a distance to a front vehicle, a relative speed with the front vehicle, a speed of the host vehicle, a steering angle, an accelerator pedal sensor (APS) value, and a brake pedal sensor (BPS) value. In addition, the controller 30 may obtain driving information of the vehicle in units of, for example, 0.1 seconds and may obtain 20 pieces of driving information for 2 seconds.

The controller 30 may predict the speed of the vehicle for the next 10 seconds in units of 1 second based on driving information obtained for 2 seconds in units of 0.1 seconds and forward information of the vehicle obtained at the time (current) of starting the prediction. In this case, the forward information of the vehicle may include information (type, curvature, gradient, and the like) about a road on which the vehicle is traveling, traffic light information (lighting color) on the road, crosswalk information (separation distance from the host vehicle, location, and the like) on the road, speed bump information (separation distance from the host vehicle, location, and the like), speed camera information (separation distance from the host vehicle, location, and the like) on the road, and the like. In addition, the controller 30 may obtain front information in units of 5 m for 500 m in front of the vehicle, for example, and may obtain a total of 100 pieces of forward information.

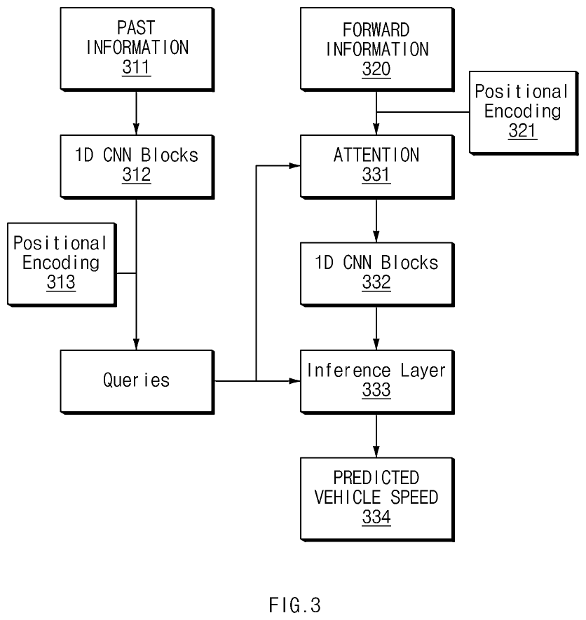

FIG. 3 is a block diagram illustrating a process of predicting the speed of a vehicle by a controller provided in an apparatus for predicting a speed of a vehicle according to an embodiment of the present disclosure.

First, in 311, the controller 30 may input past driving information of a vehicle obtained for 2 seconds in units of 0.1 seconds to a first convolutional neural network (CNN). In this case, the first CNN is a deep learning model learned to output feature information about the current state of the vehicle corresponding to past driving information of the vehicle.

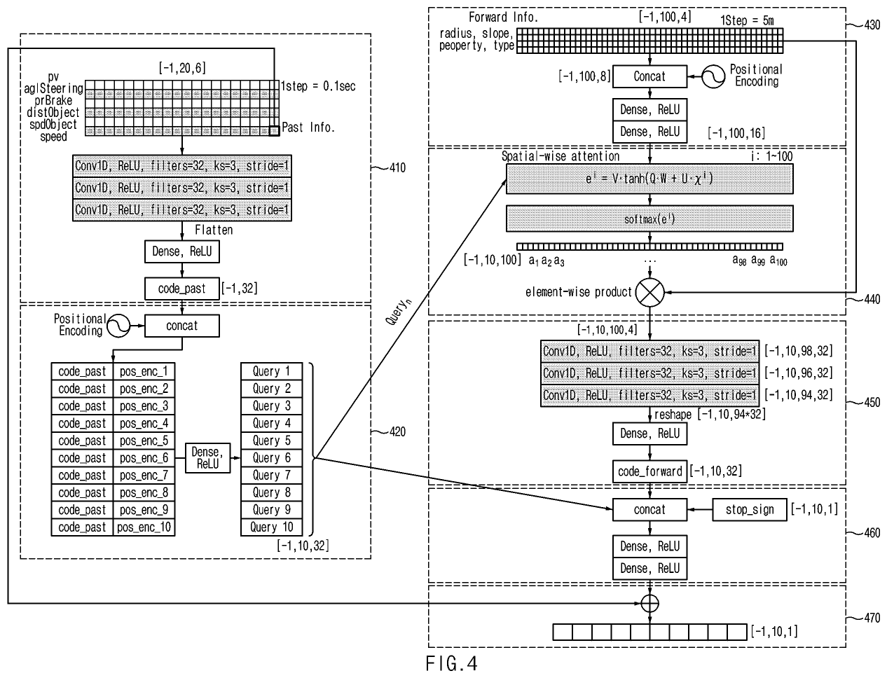

Then, in 312, the controller 30 may extract feature information about the current state of the vehicle from past driving information of the vehicle based on the first CNN. In this case, the first CNN may output ‘code past’ as the feature information about the current state of the vehicle corresponding to the past driving information of the vehicle through a process as shown in ‘410’ of FIG. 4.

Then, in 313, the controller 30 may generate a query corresponding to each target time point by performing positional encoding on the feature information on the current state of the vehicle. As an example, the controller 30, as shown in ‘420’ of FIG. 4, may generate a total of 10 queries (Query 1, Query 2, Query 3, Query 4, Query 5, Query 6, Query 7, Query 8, Query 9 and Query 10). In FIG. 4, ‘pos_enc_1’ represents a target time point after 1 second, ‘pos_enc_2’ represents a target time point after 2 seconds, ‘pos_enc_3’ represents a target time point after 3 seconds, and ‘pos_enc_4’ represents a target time point after 4 seconds, ‘pos_enc_5’ represents a target time point after 5 seconds, ‘pos_enc_6’ represents a target time point after 6 seconds, ‘pos_enc_7’ represents a target time point after 7 seconds, ‘pos_enc_8’ represents a target time point after 8 seconds, ‘pos_enc_9’ represents a target time point after 9 seconds, and ‘pos_enc_10’ represents a target time point after seconds.

In addition, the controller 30 may obtain the forward information of the vehicle from the autonomous driving system 200 in 320 and perform positional encoding on the forward information of the vehicle to generate forward information corresponding to the distance to the vehicle in 321. The generated forward information corresponding to the distance to the vehicle is shown in ‘430’ of FIG. 4.

Thereafter, in 331, the controller 30 may input the query and the forward information corresponding to the distance to the vehicle to an attention model (or function) and determine the degree of attention (attention value) for the forward information at each target time point. Such a process is shown in ‘440’ of FIG. 4. In this case, the controller 30 may determine the degree of attention based on following Equation 1.

Attention(Q,K,V)=Attention Value Equation 1:

Where “Q” represents a query, “K” represents a key, and “V” represents a value. In this case, the forward information corresponding to the distance to the vehicle may be “K” and “V”. Such an attention function obtains the similarity with all keys for each query, reflects the similarity to each value mapped with the key, and returns the sum of all values reflecting the similarity. The returned value is an attention value.

Thereafter, in 332, the controller 30 may determine the forward information corresponding to each target time point from the degree of attention for each forward information at each target time point based on the second CNN. In this case, the second CNN may output the forward information corresponding to each target time point through the process shown in ‘450’ of FIG. 4.

Thereafter, in 333, the controller 30 may predict the amount of change in speed of the vehicle at each target time point based on the query corresponding to each target time point and the forward information corresponding to each target time point based on an inference layer. In this case, the inference layer may output the amount of change in speed of the vehicle at each target time point through the process shown in ‘460’ of FIG. 4. In this case, the inference layer is a deep learning model that has been trained to output the amount of change in speed of the vehicle at each target time point based on the query corresponding to each target time point and the forward information corresponding to each target time point.

Thereafter, in 334, the controller 30 may predict the speed of the vehicle at each target time point by summing the current speed of the vehicle and the amount of change in speed of the vehicle at each target time point. As shown in ‘470’ of FIG. 4, the controller 30 may predict the speed of the vehicle for 10 seconds in units of 1 second.

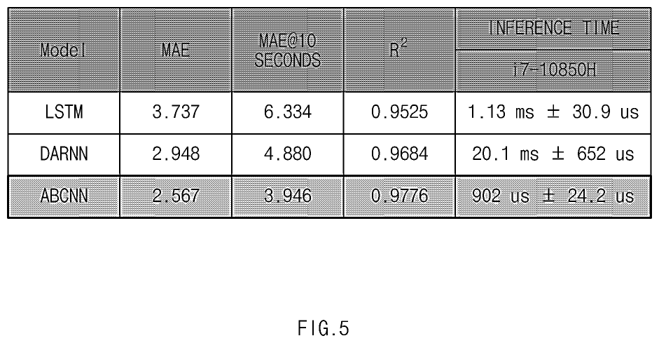

FIG. 5 is a view illustrating the performance of an apparatus for predicting a speed of a vehicle according to an embodiment of the present disclosure.

In FIG. 5, the vertical axis represents mean absolute error (MAE), and the horizontal axis represents time. In addition, reference numeral ‘510’ indicates a result of predicting a speed of a vehicle based on a long short-term memory (LSTM), reference numeral ‘520’ indicates a result of predicting a vehicle speed based on a dual-stage attention-based recurrent neural network (DARNN), and reference numeral ‘530’ indicates a result of predicting a vehicle speed based on an attention-based convolutional neural network (ABCNN) (a scheme of the present disclosure).

As shown in FIG. 5, it may be understood that the error of the result 510 of predicting a vehicle speed based on LSTM is the largest. Next, it may be understood that the error of the result 520 of predicting a vehicle speed based on DARNN is large. As a result, it may be understood that the error of the result 530 of predicting a vehicle speed based on ABCNN is the smallest. In other words, the scheme 530 of the present disclosure shows an improvement effect of 38% compared to the LSTM-based scheme 510 and shows an improvement effect of 13% compared to the DARNN-based scheme 520.

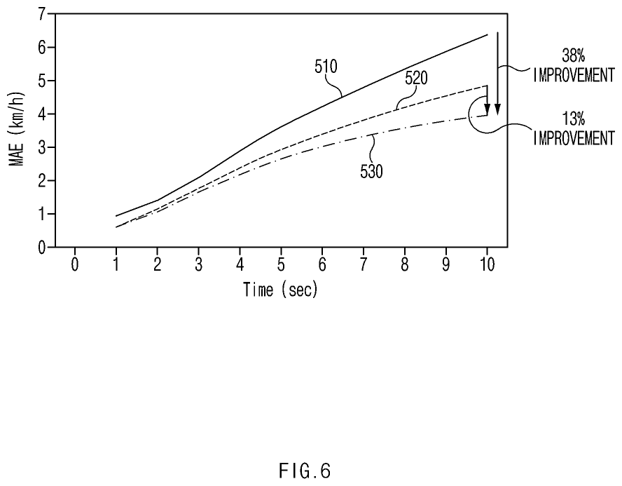

FIG. 6 is a graph illustrating the performance of an apparatus for predicting a vehicle speed according to an embodiment of the present disclosure.

In FIG. 6, MAE represents the average of the absolute error values for all samples, MAE@10 seconds represents the average of absolute error values for prediction results after 10 seconds, and R 2 is a coefficient of determination. It may be understood that the closer the coefficient of determination is to ‘1’, the better the estimate of the actual value. In addition, the inference time represents the average value (mean±standard deviation) of 10,000 inferences with a batch size of ‘1’.

As shown in FIG. 6, it may be understood that the result (the scheme of the present disclosure) of predicting a speed of a vehicle based on ABCNN is superior in performance to other schemes.

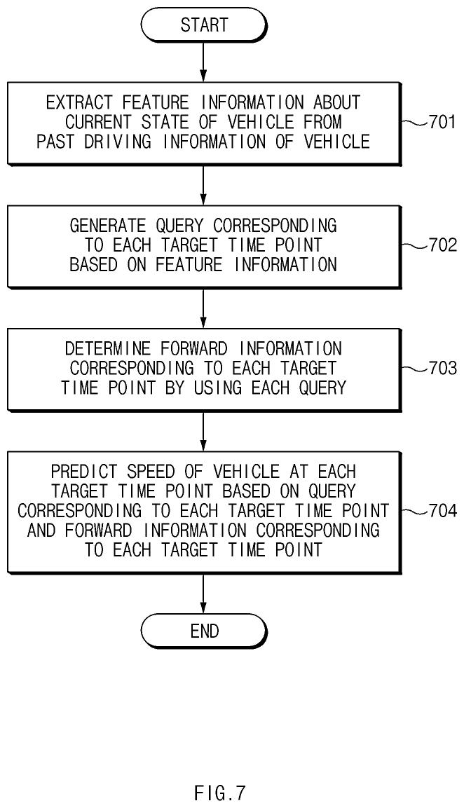

FIG. 7 is a flowchart illustrating a method of predicting a speed of a vehicle according to an embodiment of the present disclosure.

First, in operation 701, the controller 30 extracts feature information about the current state of a vehicle from past driving information of the vehicle.

Thereafter, in operation 702, the controller 30 generates a query corresponding to each target time point based on the feature information.

Thereafter, in operation 703, the controller 30 determines forward information corresponding to each target time point by using each query.

Thereafter, in operation 704, the controller 30 predicts the speed of the vehicle at each target time point based on the query corresponding to each target time point and the forward information corresponding to each target time point.

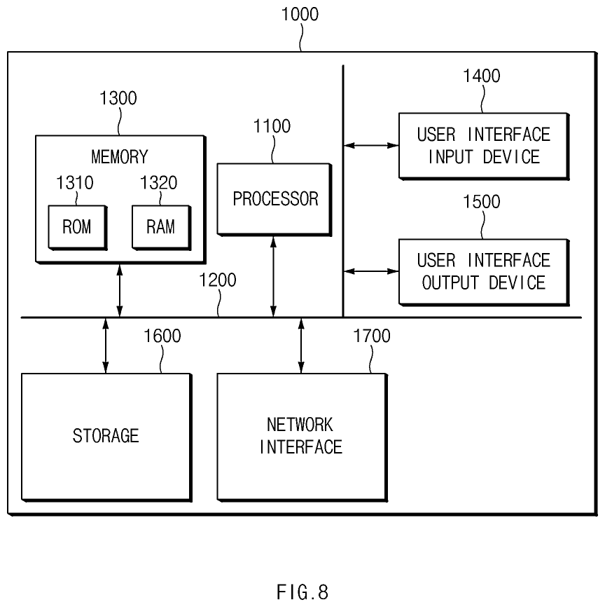

FIG. 8 is a block diagram illustrating a computing system for executing a method of predicting a speed of a vehicle according to an embodiment of the present disclosure.

Referring to FIG. 8, a method of predicting a speed of a vehicle according to an embodiment of the present disclosure described above may be implemented through a computing system. A computing system 1000 may include at least one processor 1100, a memory 1300, a user interface input device 1400, a user interface output device 1500, storage 1600, and a network interface 1700 connected through a system bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (i.e., the memory 1300 and/or the storage 1600), such as a RAM, a flash memory, a ROM, an EPROM, an EEPROM, a register, a hard disk, solid state drive (SSD), a detachable disk, or a CD-ROM. The storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

As described above, according to the embodiments of the present disclosure, an apparatus for predicting a speed of a vehicle and a method thereof may reduce the time required to predict the vehicle speed at each target time point. The apparatus and the method may extract feature information about a current state of the vehicle from past driving information of the vehicle. The apparatus and the method may generate a query corresponding to each target time point based on the feature information. The apparatus and the method may determine forward information corresponding to each target time point by using each query. The apparatus and the method may predict the speed of the vehicle at each target time point based on the query corresponding to each target time point and the forward information corresponding to each target time point.

Although embodiments of the present disclosure have been described for illustrative purposes, those having ordinary skill in the art should appreciate that various modifications, additions, and substitutions are possible, without departing from the scope and spirit of the present disclosure.

Therefore, the embodiments disclosed in the present disclosure are provided for the sake of descriptions and are not intended to limit the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for predicting a speed of a vehicle, the apparatus comprising:
storage configured to store past driving information of the vehicle; and
a controller configured to:
extract feature information about a current state of the vehicle from the past driving information of the vehicle,
generate a query corresponding to each target time point based on the feature information,
determine forward information corresponding to each target time point by using each query, and
predict the speed of the vehicle at each target time point based on the query corresponding to each target time point and the forward information corresponding to each target time point.

2. The apparatus of claim 1, wherein the controller is configured to:
predict a speed change amount of the vehicle at each target time point based on the query corresponding to each target time point and the forward information corresponding to each target time point, and
predict the speed of the vehicle at each target time point by adding the speed change amount of the vehicle at each target time point to a current speed of the vehicle.

3. The apparatus of claim 1, wherein the driving information includes at least one of a distance to a front vehicle, a relative speed with the front vehicle, a speed of the vehicle, a steering angle of the vehicle, an accelerator pedal sensor (APS) value of the vehicle, or a brake pedal sensor (BPS) value of the vehicle, or any combination thereof.

4. The apparatus of claim 1, wherein the forward information includes at least one of information about on a road on which the vehicle is traveling, traffic light information on the road, crosswalk information on the road, speed bump information on the road, or speed camera information on the road, or any combination thereof.

5. The apparatus of claim 1, wherein the controller is configured to extract the feature information about the current state of the vehicle from the past driving information of the vehicle based on a first convolutional neural network (CNN).

6. The apparatus of claim 1, wherein the controller is configured to generate the query corresponding to each target time point by performing positional encoding on the feature information about the current state of the vehicle.

7. The apparatus of claim 1, wherein the controller is configured to obtain the forward information of the vehicle and perform positional encoding on the forward information of the vehicle to generate the forward information according to a distance to the vehicle.

8. The apparatus of claim 7, wherein the controller is configured to input the forward information according to each query and the distance to the vehicle to an attention model and determine an attention value for each forward information at each target time point based on the attention model.

9. The apparatus of claim 8, wherein the controller is configured to determine the forward information corresponding to each target time point from the attention value for each forward information at each target time point based on a second convolutional neural network (CNN).

10. The apparatus of claim 1, wherein the controller is configured to determine the forward information having greatest influence on the speed of the vehicle at each target time point as the forward information corresponding to each target time point.

11. A method of predicting a speed of a vehicle, the method comprising:
extracting, by a controller, feature information about a current state of the vehicle from past driving information of the vehicle;
generating, by the controller, a query corresponding to each target time point based on the feature information;
determining, by the controller, forward information corresponding to each target time point by using each query; and
predicting, by the controller, the speed of the vehicle at each target time point based on the query corresponding to each target time point and the forward information corresponding to each target time point.

12. The method of claim 11, wherein the predicting of the speed of the vehicle includes:
predicting a speed change amount of the vehicle at each target time point based on the query corresponding to each target time point and the forward information corresponding to each target time point; and
predicting the speed of the vehicle at each target time point by adding the speed change amount of the vehicle at each target time point to a current speed of the vehicle.

13. The method of claim 11, wherein the driving information includes at least one of a distance to a front vehicle, a relative speed with the front vehicle, a speed of the vehicle, a steering angle of the vehicle, an accelerator pedal sensor (APS) value of the vehicle, or a brake pedal sensor (BPS) value of the vehicle, or any combination thereof.

14. The method of claim 11, wherein the forward information includes at least one of information about on a road on which the vehicle is traveling, traffic light information on the road, crosswalk information on the road, speed bump information on the road, or speed camera information on the road, or any combination thereof.

15. The method of claim 11, wherein the extracting of the feature information includes:
extracting the feature information about the current state of the vehicle from the past driving information of the vehicle based on a first convolutional neural network (CNN).

16. The method of claim 11, wherein the generating of the query includes:
generating the query corresponding to each target time point by performing positional encoding on the feature information about the current state of the vehicle.

17. The method of claim 11, wherein the determining of the forward information includes:
obtaining the forward information of the vehicle;
performing positional encoding on the forward information of the vehicle to generate the forward information according to a distance to the vehicle;
inputting the forward information according to each query and the distance to the vehicle to an attention model;
determining an attention value for each forward information at each target time point based on the attention model; and
determining the forward information corresponding to each target time point from the attention value for each forward information at each target time point based on a second convolutional neural network (CNN).

18. The method of claim 11, wherein the determining of the forward information includes:
determining the forward information having greatest influence on the speed of the vehicle at each target time point as the forward information corresponding to each target time point.
